(19) United States
(12) Patent Application Publication
(10) Pub. No.: US 2010/0219219 A1
(43) Pub. Date: Sep. 2, 2010

(54) Shopping bag container

(76) Inventor: Michael J. Svetina, Castiac, CA (US)

Correspondence Address: ALBERT O COTA, 5460 WHITE OAK AVE, SUITE A-331, ENCINO, CA, 91316, US

(21) Appl. No.: 12/380,393

(22) Filed: Feb. 27, 2009

(51) Int. Cl. B60R 9/00

(52) U.S. Cl. 224/411

(57) ABSTRACT

A shopping bag container (SBC 10) that is designed to be releasably attached to a structural member located on a conventional shopping cart (160). The SBC 10 is comprised of three major elements: an inner section (12), an outer section (58) and an expandable divider (90) that is attached between the inner section (12) and the outer section (58). The expandable divider (90) is preferably comprised of an accordion structure (92) that allows the SBC (10) to be placed in either a flat configuration or in an expanded configuration. The flat configuration is utilized when the SBC (10) is stored or when being carried. When the accordion structure (92) is placed in the expanded position several shopping bags (164) can be conveniently inserted and stored in the SBC (10) for later use.

### TECHNICAL FIELD

The invention generally pertains to the field of structures that are designed to temporarily retain shopping bags, and more particularly to a shopping bag container that is releaseably attached to a structure located on the front end of a grocery shopping cart.

### BACKGROUND ART

The use of shopping carts to transport selected items while shopping is common practice in most supermarkets and other departmental stores. A shopper is provided with the shopping cart, which they use for the duration of their shopping. After the selected products are paid for and placed into bags, the shopper will often then use the shopping cart to transport the bagged products to their vehicles.

The bags that the products are placed into are either made of plastic or paper. In today's green environment many shoppers prefer paper bags which degrade much more quickly than plastic bags. The stores however, typically prefer the plastic bags which cost less to provide than the paper bags. To alleviate this problem, many shoppers choose to purchase a bag made of fabric, which they bring to the store each time they shop.

The instant invention solves the green environment problem by providing a shopping bag container (SBC) into which can be carried a number of environment-friendly bags. The SBC is designed to be attached to a structural member of the shopping cart.

A search of the prior art did not disclose any literature or patents that read on the claims of the instant application. However, the following U.S. patents were considered related.

| PATENT NO. | INVENTOR | ISSUED |
|---|---|---|
| 6,056,178 | Rapp-Duncan | 2 May 2000 |
| 4,069,994 | Wharmby | 24 Jan. 1978 |
| 3,861,633 | Rappleye | 21 Jan. 1975 |
| 3,861,630 | Ady | 21 Jan. 1975 |

The U.S. Pat. No. 6,056,178 patent discloses an auxiliary bin that is secured to a mesh bin of a shopping cart. The auxiliary bin includes a small open grid work for holding small toys, cosmetics, candy, etc., that would fall through the larger openings in the grid of the shopping cart. The auxiliary bin is attachable via a bracket to the grid work of the shopping cart.

The U.S. Pat. No. 4,069,994 patent discloses a bag holder of the type wherein the bag is received and supported by a frame of variable shape. The frame is made of two elements, one element is attached to one side of a frame support and the other element is attached to an opposite side of the frame support.

The U.S. Pat. No. 3,861,633 patent discloses a hook that is fastened to a metal plate which is bolted to a side of a shopping cart. The hook retains a pocketbook belonging to the user of the cart while shopping. The hook is pivotably mounted so as to swivel in the horizontal plane and is fitted with a spring to fix the hook in a latched position.

The U.S. Pat. No. 3,861,630 patent discloses an adjustable mounting bar that includes a set of mounting structures for mounting the bar from a support surface. A pair of support fixtures are supported from the bar wherein each support fixture includes an outward portion. A plastic bag has its open end slipped over the outward portions for supporting the bag.

For background purposes and as indicative of the art to which the invention relates, reference may be made to the following remaining patents found in the search.

| PATENT NO. | INVENTOR | ISSUED |
|---|---|---|
| 5,002,245 | Hansen et al | 26 Mar. 1991 |
| 3,479,085 | Weinstein | 18 Nov. 1969 |
| 2,582,650 | Patton | 15 Jan. 1952 |
| 2,507,842 | Waddill | 16 May 1950 |
| 1,656,339 | Runyan | 17 Jan. 1928 |
| 396,561 | Harrison | 22 Jan. 1889 |

### DISCLOSURE OF THE INVENTION

In todays shopping scenario many grocery stores and the like do not provide shoppers with environment-friendly bags for carrying purchased merchandise. To alleviate this problem the shopping bag container (SBC) provides a convenient and practical method for shoppers to carry their own environment-friendly bags. The SBC is designed to be releasably attached to an upper horizontal rod that is located on a frame structure of a typical shopping cart.

In its basic design configuration the SBC is comprised of

a) An inner section having an inner side, an outer side, a right edge, a left edge, an upper edge and a lower edge. The inner section includes a means for attaching the SBC to the cart's upper horizontal rod.

b) An outer section having an inner side, an outer side a right edge, a left edge, an upper edge and a lower edge.

c) An expandable divider having an inner member and an outer member. The inner member has means for being attached to the inner side of the inner section and the outer member has means for being attached to the inner side of the outer section.

The dimensions of both the inner section and the outer section are similar and they are both made of a material that can consist of a metal such as aluminum, plastic, wood or reinforced cardboard. The inner side of the inner section and the outer side of the outer section have at least one pocket to enhance the utility of the SBC.

The expandable divider can consist of an accordion structure having one center-foldable flap or an accordion structure having multiple center-foldable flaps that allow several shopping bags to be inserted into the SBC. The expandable divider also allows the SBC to be folded into a flat structure when the SBC is not in use or is being stored.

In view of the above disclosure, the primary object of the invention is to provide an SBC that provides a shopper with the means to conveniently carry a number of environment-friendly grocery or similar bags. The SBC is designed to be releasably attached to a structure that is preferably located on the front of a typical shopping cart.

In addition to the primary object of the invention it is also an object of the invention to produce a SBC that:

can be made in various sizes,

has an aesthetic appearance,

easily recognizable when shopping,

is convenient and practical,

can be adapted for use with hand-held shopping baskets, and

is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a perspective view of a shopping bag container (SBC) that is attached by a pair of hooks to a horizontal rod that is located on a front structure of a shopping cart.

FIG. 2 is a perspective view of an SBC removed from the shopping cart.

FIG. 3 is a perspective view of an SBC removed from the shopping cart and shown with a pair of shopping bags inserted into a pair of accordion flaps.

FIG. 4 is an elevational view of the inner side of an inner section which comprises an element of the SBC.

FIG. 5 is a perspective view of a rod attachment means that is comprised of an elongated strip that is fastened by hook and loop fasteners.

FIG. 6 is a side elevational view of the hook and loop fasteners shown in FIG. 5.

FIG. 7 is a perspective view of a rod attachment means that is comprised of an elongated strip that is fastened by male and female detents.

FIG. 8 is a side elevational view of the male and female detents shown in FIG. 7.

FIG. 9 is a front elevational view of a rod attachment means that is comprised of an articulated flap that is attached to the upper edge of the inner section by means of a living hinge and an accordion structure.

FIG. 10 is a side elevational view of the articulated flap shown in FIG. 9.

FIG. 11 is a front elevational view of a rod attachment means that is comprised of an elongated plate to which is attached a pair of spring-loaded hooks.

FIG. 12 is a side elevational view of the elongated plate and the spring-loaded hooks shown in FIG. 11.

FIG. 13 is an elevational view of the outer side of an outer section which comprises an element of the SBC.

FIG. 14 is a side elevational view of an accordion structure having a single flap.

FIG. 15 is a top plan view of the single flap accordion structure shown in FIG. 14.

FIG. 16 is a side elevational view of an accordion structure having multiple flaps.

FIG. 17 is a top plan view of the multiple flaps accordion structure shown in FIG. 16.

### BEST MODE FOR CARRYING OUT THE INVENTION

The best mode for carrying out the invention is presented in terms of a preferred embodiment for a shopping bag container (SBC) 10 that is designed to be releasably attached to a horizontal rod 162 which is attached preferably to a front structure of a typical shopping cart 160.

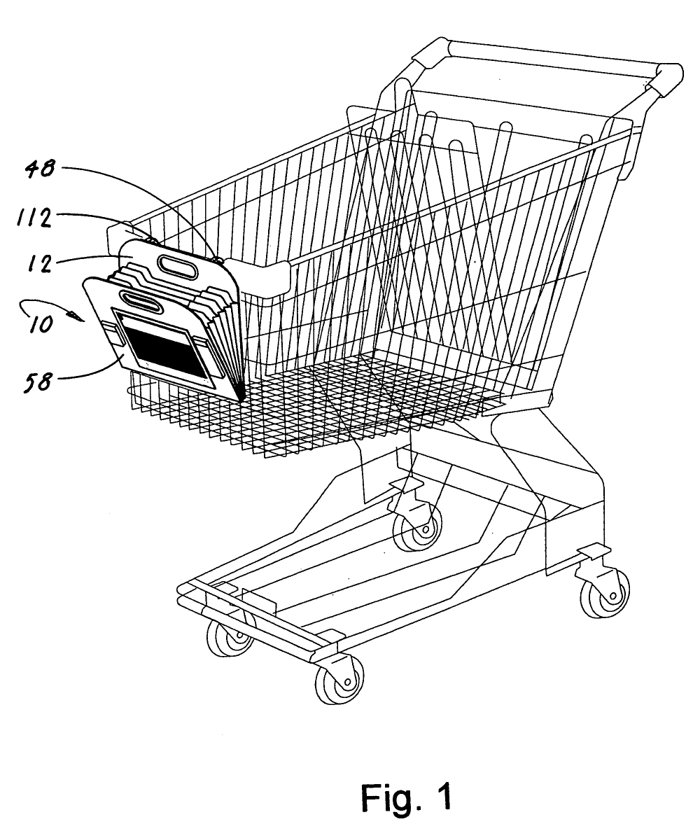

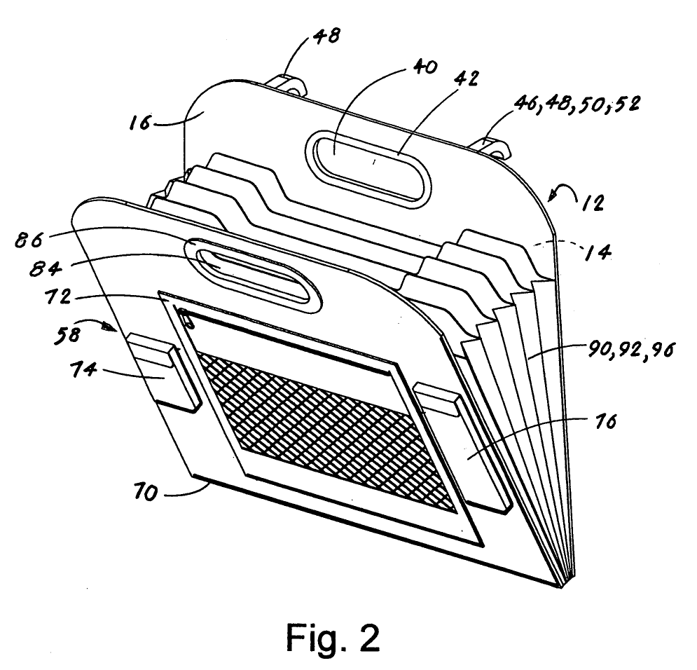

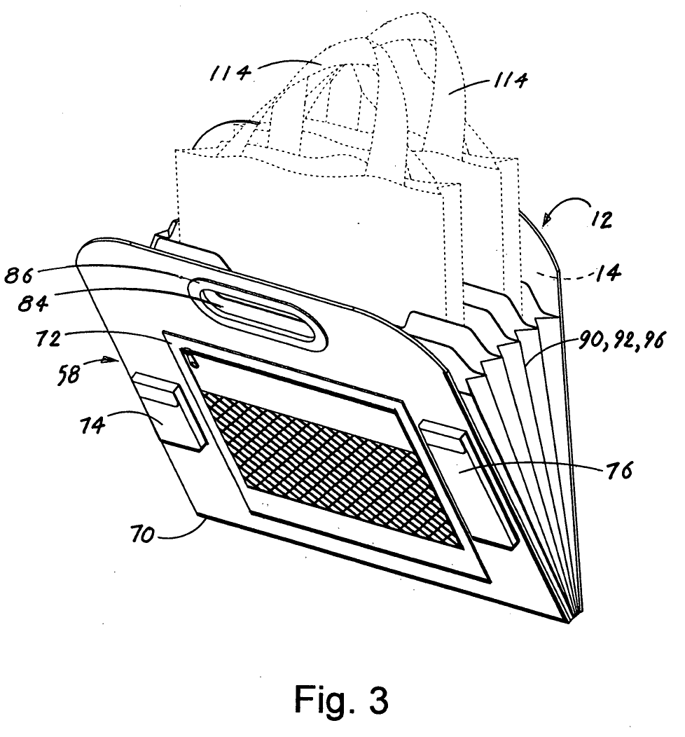

The preferred embodiment of the SBC 10, as shown in FIGS. 1-17, is comprised of three major elements: an inner section 12, an outer section 58 and an expandable divider 90 that is attached between the inner section 12 and the outer section 58. The SBC 10 is shown attached to a typical shopping cart 160 in FIG. 1, removed from the shopping cart 160 in FIG. 2, and removed from the shopping cart 160 with a pair of shopping bags 164 inserted into the SBC 10 in FIG. 3.

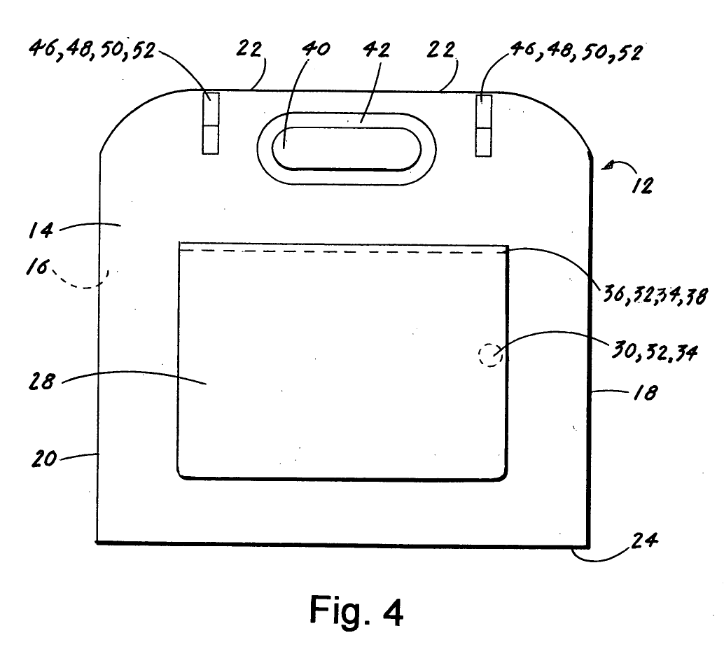

The inner section 12, as best shown in FIG. 4, is comprised of an inner side 14, an outer side 16, a right side 18, a left side 20, an upper edge 22, and a lower edge 24. To enhance the utility of the inner section 12, a pocket 28 can be removably attached by an attachment means 30 to the inner side 14. The pocket attachment means 30 can be comprised of hook and loop fasteners 32 or a set of male and female detents 34. The pocket 28 can also be designed to include an opening and closing means 36 that is selected from the group consisting of hook and loop fasteners 32, a set of male and female detents 34 and a zipper 38. To facilitate carrying the SBC 10 when it is not attached to the shopping cart 160, an inner hand-opening 40 is centrally located adjacent to the upper edge 22 of the inner section 12, as shown best in FIG. 4. A resilient grommet 42 can be inserted into the inner hand-opening 40 to add comfort to the person carrying the SBC 10.

To utilize the SBC 10, the inner section 12 includes adjacent to the upper edge 22, a rod attachment means 46 for being releasably attached, as shown in FIG. 1, to a horizontal rod 162 that is located on the front or rear and preferably the front of a shopping cart 160, as shown in FIG. 1. The rod attachment means 46 is selected from the group consisting of:

At least one centrally located hook 48, and preferably two hooks 48, as shown in FIG. 4, that are each dimensioned to slip over the horizontal rod 162 of the shopping cart 160.

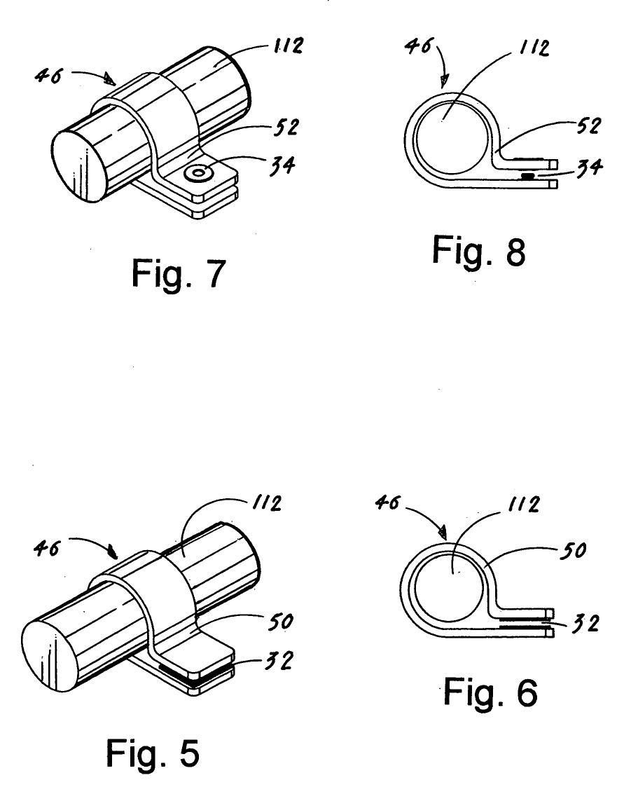

An elongated strip 50 that is dimensioned to be wrapped around the horizontal rod 162 by means of a hook and loop fastener 32, as shown in FIGS. 5 and 6.

An elongated strip 52 that is dimensioned to be wrapped around the horizontal rod 162 by means of male and female detents 34, as shown in FIGS. 7 and 8.

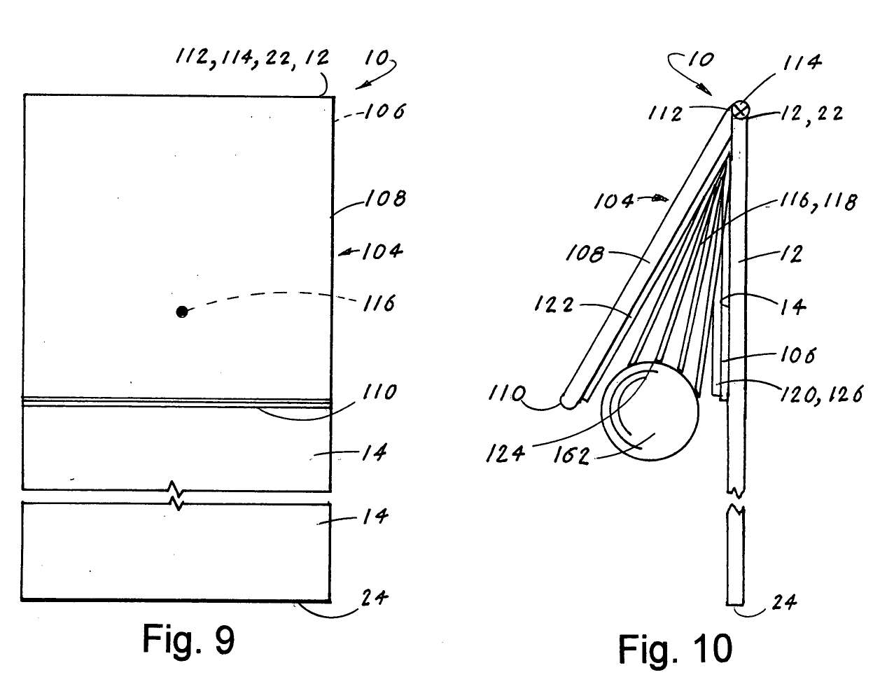

An articulated tab 104, as shown in FIGS. 9 and 10, having an inner surface 106 that is attached to inner side 14 of the inner section 12, an outer surface 108, a lower edge 110, and an upper edge 112 that is hingedly attached by a living hinge 114 to the upper edge 22 of the inner section 12. Between the inner surface 106 and the outer surface 108 is attached an accordion structure 116 that is comprised of multiple flaps 118 having an inner member 120, an outer member 122 and a lower end 124. The inner member 120 is attached to the inner surface 106 by an adhesive 126, the outer member 122 is attached to the outer surface 108 also by the adhesive 126, and the lower end 124 of the flaps 118 are radiused to fit over the horizontal rod 162 of the shopping cart 160.

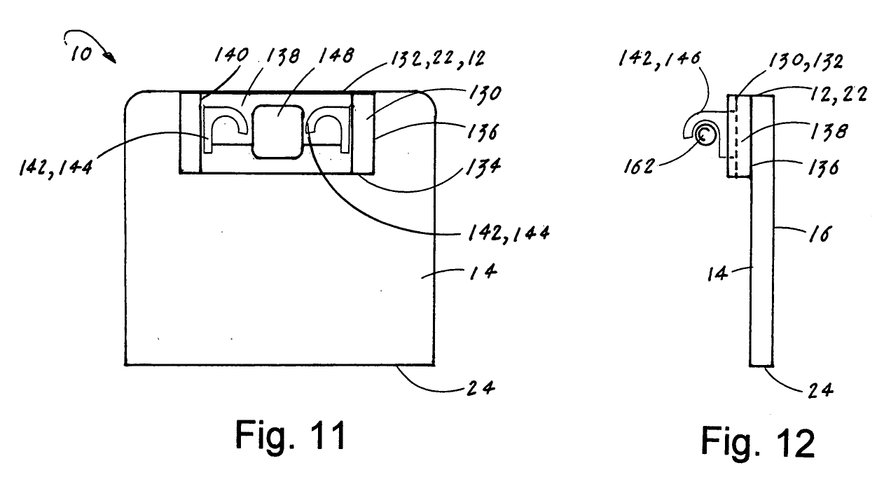

An elongated plate 130, as shown in FIGS. 11 and 12, having an upper edge 132 and a lower edge 134 wherein the upper edge 132 is attached adjacent to the upper edge 22 of the inner section 12 by an attachment means 136. The plate 130 has a central indentation 138 that has attached adjacent to each end 140 of the indentation 138 a spring-loaded hook 142. The hook 142 is released from a retracted position 144, as shown in FIG. 11, to an extended functional position 146, as shown in FIG. 12, when a spring-release clip 148 that is located between the two hooks 142 is depressed.

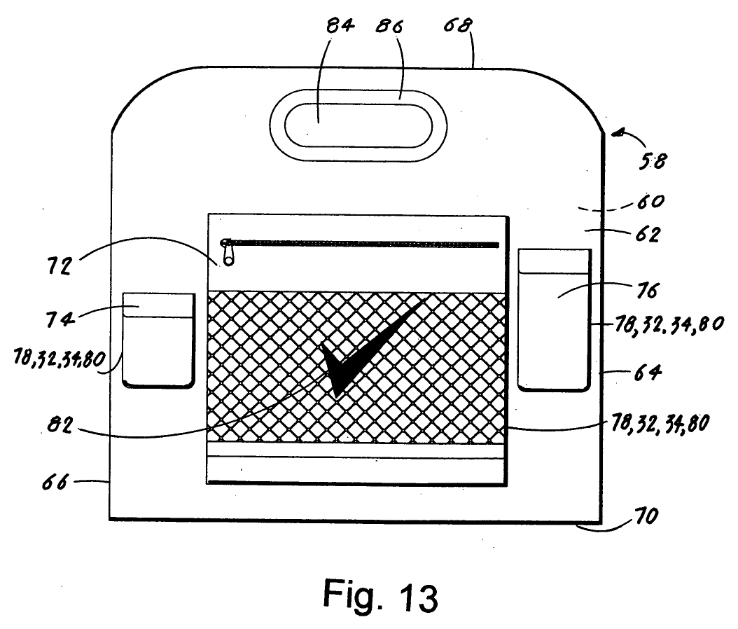

The outer section 58, as best shown in FIG. 13, is comprised of an inner side 60, an outer side 62, a right edge 64 a left edge 66, an upper edge 68 and a lower edge 70. To enhance the utility of the SBC 10, the outer section 58 can be designed to include at least three pockets 72, 74 and 76 as shown in FIGS. 2 and 13. The pocket 72 can be made of a solid material or with a netting, as shown in FIG. 13, and the pocket 76 is preferably dimensioned to enclose a hand-held electronic device such as a cellular telephone (not shown). Each of the pockets 72, 74 and 76 are attached by an attachment means 78 that can be selected from the group consisting of an adhesive 80, hook and loop fasteners 32 or a set of male and female detents 34. At least one of the pockets, as shown in FIG. 13, can include indicia 82 such as advertising indicia. The indicia is visible from the front of the shopping cart 160 when the SBC 10 is attached to the rod 162 located on the front of the shopping cart 160, as shown in FIG. 1. The outer section 58 includes an outer hand-opening 84 that is centrally located adjacent to the upper edge 68 of the outer section 58. The two inner and outer hand-openings 40, 84 are located in concentric alignment when the inner section 12 interfaces with the outer section 58. The outer hand-opening 84 also includes a resilient grommet 86.

The inner section 12 and the outer section 58 each have a height that ranges from 6.0 to 12.0 inches (15.24 to 30.48 cm), a width that ranges from 8.0 to 12.0 (20.32 to 30.48 cm) and a thickness that ranges from 0.0623 to 0.125-inches (0.159 to 0.318 cm). Additionally, the two sections 12, 58 are made of a material that is selected from the group consisting of metal, plastic or cardboard. If the metal selected is aluminum, it can be anodized in selectable colors.

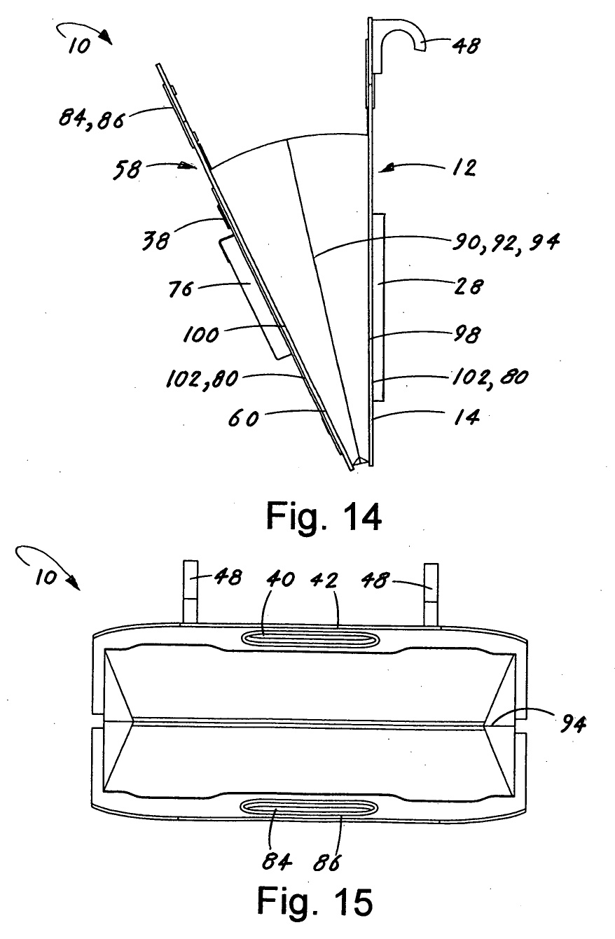

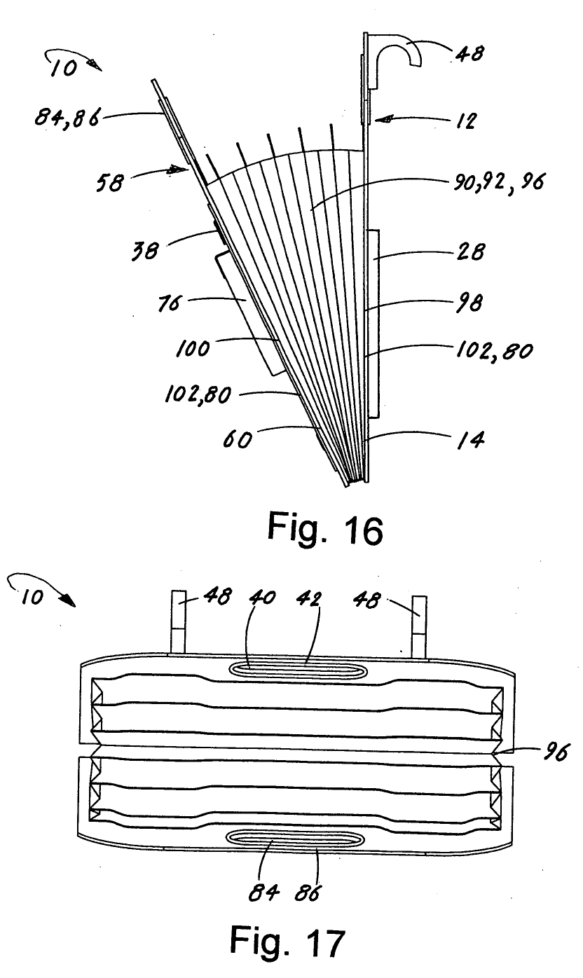

The third and final major element that comprises the SBC 10 is the expandable divider 90 that is preferably comprised of an accordion structure 92 having a single center-foldable flap 94, as shown in FIGS. 14 and 15, or multiple center-foldable flaps 96, as shown in FIGS. 16 and 17. Both the single and the multiple center-foldable flaps 94, 96 have an inner member 98 and an outer member 100. The inner member 98 is attached by an attachment means 102 that is preferably comprised of an adhesive 80, to the inner side 14 of the inner section 12, as shown in FIG. 14. Likewise, the outer member 100 is attached by the attachment means 102 to the inner side 60 of the outer section 58, as shown in FIG. 16.

Other shopping bag containment structures can be utilized to practice the inventive SBC 10. However, the use of an accordion file 92 allows the SBC 10 to be compactly folded when being stored or not in use, or to be easily opened to allow a plurality of shopping bags 114, or the like to be easily inserted into and easily removed form the SBC 10.

While the invention has been described in detail and pictorially shown in the accompanying drawings it is not to be limited to such details, since many changes and modifications may be made to the invention without departing from the spirit and the scope thereof For example, additional pockets that can securely hold a water bottle or an umbrella can be located on the various surfaces that comprise the SBC 10. Hence, it is described to cover any and all modifications and forms which may come within the language and scope of the claims.

SHOPPING BAG CONTAINER
Element Designation

| | |
|---|---|
| 10 | Shopping Bag Container (SBC) |
| 12 | Inner Section |
| 14 | Inner Side |
| 16 | Outer Side |
| 18 | Right Edge |
| 20 | Left Edge |
| 22 | Upper Edge |
| 24 | Lower Edge |
| 26 | |
| 28 | Pocket |
| 30 | Attachment Means |
| 32 | Hook and Loop Fastener |
| 34 | Male and Female Detents |
| 36 | Opening and Closing Means |
| 38 | Zipper |
| 40 | Inner Hand Opening |
| 42 | Resilient Grommet |
| 44 | |
| 46 | Attachment Means |
| 48 | Hook |
| 50 | Elongated Hook and Loop Strip |
| 52 | Elongated Male and Female Strip |
| 54 | |
| 56 | |
| 58 | Outer Section |
| 60 | Inner Side |
| 62 | Outer Side |
| 64 | Right Edge |
| 66 | Left Edge |
| 68 | Upper Edge |
| 70 | Lower Edge |
| 72 | Pocket |
| 74 | Pocket |
| 76 | Cell Phone Pocket |
| 78 | Attachment Means |
| 80 | Adhesive |
| 82 | Indicia |
| 84 | Outer Hand Opening |
| 86 | Resilient Grommet |
| 88 | |
| 90 | Expandable Divider |
| 92 | Accordion Structure |
| 94 | Single Flap |
| 96 | Multiple Flaps |
| 98 | Inner Member |
| 100 | Outer Member |
| 102 | Attachment Means |
| 104 | Articulated Tab |
| 106 | Inner Surface |
| 108 | Outer Surface |
| 110 | Lower Edge |
| 112 | Upper Edge |
| 114 | Living Hinge |
| 116 | Accordion Structure |
| 118 | Multiple Flaps |
| 120 | Inner Member |
| 122 | Outer Member |
| 124 | Lower End |
| 126 | Adhesive |
| 128 | |
| 130 | Elongated Plate |
| 132 | Upper Edge |
| 134 | Lower Edge |
| 136 | Attachment Means |
| 138 | Central Indentation |
| 140 | End of Indentation |
| 142 | Spring-Loaded Hook |
| 144 | Retracted Position |
| 146 | Extracted Position |
| 148 | Spring-Release Clip |
| 150 | |
| 152 | |
| 154 | |
| 156 | |
| 158 | |
| 160 | Shopping Cart |
| 162 | Horizontal Rod |
| 164 | Shopping Bags |

1. A shopping bag container (SBC) that is releasably attached to an upper horizontal rod located on a structure of a typical shopping cart, said SBC comprising:
a) an inner section having an inner side, an outer side, a right edge, a left edge, an upper edge and a lower edge,
b) an outer section having an inner side, an outer side, a right edge, a left edge, an upper edge and a lower edge, and
c) an expandable divider that is attached between the inner sides of said inner section and said outer section.

2. The shopping bag container as specified in claim 1 wherein said inner section and said outer section each have a height that ranges from 6.0 to 12.0 inches (15.24 to 30.48 cm), a width that ranges from 8.0 to 12.0 inches (20.32 to 30.48 cm) and a thickness that ranges from 0.0623 to 0.125-inches (0.159 to 0.318 cm).

3. The shopping bag container as specified in claim 1 wherein said inner section and said outer section are made of a material that is selected from the group consisting of metal, plastic, wood and cardboard.

4. The shopping bag container as specified in claim 3 wherein said metal is comprised of aluminum that is anodized in selectable colors.

5. The shopping bag container as specified in claim 1 further comprising a pocket that is removably attached by an attachment means to the inner side of said inner section.

6. The shopping bag container as specified in claim 5 wherein said pocket attachment means is comprised of hook and loop fasteners or a set of male and female detents.

7. The shopping bag container as specified in claim 6 wherein said pocket further comprises an opening and closing means that is selected from the group consisting of hook and loop fasteners, a set of male and female detents and a zipper.

8. The shopping bag container as specified in claim 1 wherein said inner section further comprises an inner hand-opening that is centrally located adjacent to the upper edge of said inner section.

9. The shopping bag container as specified in claim 8 wherein the inner hand-opening further includes a resilient grommet.

10. The shopping bag container as specified in claim 1 wherein the outer side of said inner section further comprises adjacent to the upper edge a means for being eleasably attached to the upper horizontal rod located on the shopping cart.

11. The shopping bag container as specified in claim 10 wherein said means for releasably attaching said SBC to the cart's upper horizontal rod is selected from the group consisting of
a) at least one hook that is dimensioned to slip over the horizontal rod,
b) an elongated strip having a hook and loop fastener that is wrapped around the horizontal rod and fastened thereto,
c) an elongated strip having a male and female detent that is wrapped around the horizontal rod and fastened thereto,
d) an articulated tab having an inner surface that is attached to the inner side of said inner section, an outer surface, a lower edge, and an upper edge that is hingedly attached by a living hinge to the upper edge of said inner section, wherein between the inner surface and the outer surface is attached an accordion structure that is comprised of multiple flaps having an inner member, an outer member and a lower end, wherein the inner member is attached to the inner surface by an adhesive, the outer member is attached to the outer surface by the adhesive and the lower end of the flaps are radiused to fit over the horizontal rod of the shopping cart, and
e) an elongated plate having an upper edge and a lower edge wherein the upper edge is attached adjacent to the upper edge of said inner section by an attachment means, with said plate having a central indentation that has attached adjacent to each end of the indentation a spring-loaded hook that is released from a retracted position to an extracted functional position when a spring-release clip that is located between the two hooks is depressed.

12. The shopping bag container as specified in claim 1 further comprising three pockets that are each attached by an attachment means to the outer side of said outer section.

13. The shopping bag container as specified in claim 12 wherein one of said at least three pockets is dimensioned to enclose a hand-held electronic device.

14. The shopping bag container as specified in claim 13 wherein said pocket attachment means is selected from the group consisting of an adhesive, hook and loop fasteners and a set of male and female detents.

15. The shopping bag container as specified in claim 12 wherein at least one of said pockets comprises indicia that is visible from the front of the shopping cart.

16. The shopping bag container as specified in claim 1 wherein said outer section further comprises an outer hand-opening that is centrally located adjacent to the upper edge, and that is in concentric alignment with the inner hand-opening when the inner section interfaces with the outer section.

17. The shopping bag container as specified in claim 16 wherein the outer hand-opening further includes a resilient grommet.

18. The shopping bag container as specified in claim 1 wherein said expandable divider is comprised of an accordion structure that has a single center-foldable flap having:
a) an inner member that is attached by an adhesive to the inner side of said inner section, and
b) an outer member that is attached by the adhesive to the inner side of said outer section.

19. The shopping bag container as specified in claim 1 wherein said expandable divider is further comprised of an accordion structure having multiple center-foldable flaps having:
a) an inner member that is attached by an adhesive to the inner side of said inner section, and
b) an outer member that is attached by the adhesive to the inner side of said outer section.

20. A shopping bag container (SBC) that is releasably attached to an upper horizontal rod located on a front structure of a typical shopping cart, said SBC comprising:
a) an inner section having:
(1) an inner side, an outer side, a right edge, a left edge, an upper edge and a lower edge,
(2) at least one pocket that is attached to the outer side,
(3) an inner hand-opening located adjacent to the upper edge,
(4) a pair of hooks that are attached to the outer side, wherein the hooks are dimensioned to fit over the upper horizontal rod located on the shopping cart,
b) an outer section having:
(1) an inner side, an outer side, a right edge, a left edge, an upper edge and an lower edge,
(2) a plurality of pockets that are attached to the outer side, wherein one of the pockets is dimensioned to enclose a hand-held electronic device,
(3) an outer hand-opening that is located adjacent to the upper edge, and is in concentric alignment with the inner hand-opening, and
c) an expandable divider that is comprised of an accordion structure having multiple center-foldable flaps that terminate with an inner member and an outer member, wherein the inner member is attached to the inner side of said inner section and the outer member is attached to the inner side of said outer member.
